(19) United States
(12) Patent Application Publication
(10) Pub. No.: US 2005/0008817 A1
(43) Pub. Date: Jan. 13, 2005

(54) Roll of paperband

(76) Inventors: Peter A. Rodriguez, Jacksonville, FL (US); Floyd M. Lockamy, Jacksonville, FL (US)

Correspondence Address: ARTHUR G. YEAGER, P.A., 245-1 EAST ADAMS STREET, JACKSONVILLE, FL, 32202-3336, US

(21) Appl. No.: 10/878,727

(22) Filed: Jun. 28, 2004

Related U.S. Application Data
(63) Continuation-in-part of application No. 10/617,418, filed on Jul. 11, 2003.

(51) Int. Cl. B32B 5/00

(52) U.S. Cl. 428/98

(57) ABSTRACT

Paperband useable in paper web cutting turn-up systems or baling operations includes a core of one or more elongate elements with long creases with air spaces disposed throughout and providing non-uniform and non-planar outer surfaces. Long covering member has a smooth outer surface folded about the core and overlapping side edge portions adhesively attached together and to the core. Cover may include thin and pliable outer edge portions extending substantially equidistant laterally inwardly or the core may be scored or perforated before being wrapped by the cover. The core may be formed of one or more elements that have been shredded into ribbons and adhesively attached to each other and to the cover or one or more elongate elements. Outer edge portions are readily bendable to release from a slotted track. The outer edge portions may include longitudinal or transverse scoring. Band may be thicker along its long axis.

### CROSS REFERENCE TO RELATED APPLICATIONS

This application is a Continuation-in-Part of the application entitled “ROLL OF PAPERBAND”, Ser. No. 10/617,418, filed Jul. 11, 2003.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a roll of paperband including a core formed from at least one element having a non-uniform and non-planar outer surface and a covering member about the core.

2. Prior Art

It is common practice in the papermaking and packaging industries to employ paperband or strap that is loaded into a channel of a track assembly and then removed rapidly out of the channel and employed to cut and spool a web of paper onto an empty spool or to be used to wrap around and secure a load, container or a bundle of material. Because the paperband should be stiff enough to be pushed into the channel from one end thereof, the band may twist or otherwise be distorted or separated during upward movement that is accomplished by a “stripping” action during removal from the paperband track assembly. This becomes a very important consideration in those applications where the width of the channel opening is made less than the width of the band or tape and the lower tape-carrying guide way of the channel in order to cover and carry the tape. An improved paperband is disclosed herein that greatly reduces the distortion and crimping common to prior art paperbands, reduces the wear on the guide way channel and its cover, and also reduces the separation of layers in bands made from multiple layers and from yarns formed side-by-side into a cutting or banding tape.

### BRIEF SUMMARY OF THE INVENTION

In view of the foregoing background, it is therefore an object of the invention to provide a roll of paperband that overcomes the above-noted shortcomings. These and other objects, features, and advantages of the invention, are provided by a paperband for use in paper web cutting and turn-up systems or for use in baling wherein an elongate core includes an elongate element having a longitudinal axis with a plurality of longitudinal creases disposed throughout to form the core with a non-uniform and non-planar outer surface. An elongate covering member is folded about the core, and includes a generally smooth outer surface extending along the core and having a central long axis and side edge portions spaced from and substantially parallel to the central axis with one side edge portion overlapping another side edge portion and adhesively attached to each other and the core is adhesively attached to the covering member.

Other aspects are seen in the plurality of longitudinal creases defining a plurality of randomly non-uniform fold angles relative to a plane of the core, and providing differing spatial dimensions therebetween. The element and covering member are deformable to permit formation into predetermined shapes particularly having a generally rectangular cross-sectional shape. Further, at least another element, being substantially a similar element, which is disposed side-by-side and substantially parallel to each other along longitudinal axes. The paperband has elongate outer edge portions spaced from the longitudinal axes, which extend substantially equidistant laterally inwardly and form thin and pliable portions which are readily bendable upwardly and downwardly to permit ease of release from a slotted track of a web tum-up system. Such pliable portions may have a plurality of creases extending laterally thereacross for providing a serrated surface to enhance cutting of a paper web in a web turn-up system. The core may be thicker along the longitudinal axis. The multiple creases of the core material provides an increase in the tear resistance of the paperband. The element may be twisted generally about its axis prior to being enveloped by the covering member. The element may be shredded into ribbons along its axis prior to being covered by the covering member. The shredding of inner member into a plurality of elements provides an increase in the tear resistance of the paperband. The ribbons would be adhesively bonded together and to the covering member. Such adhesive bonding of the shredded inner member to each other and to the covering member enhances the overall strength of the paperband.

Additional aspects are found in the core being formed of paper, as well as the covering member. The element may be convoluted along the axis prior to being covered by the covering member. The core may include at least another element that is convoluted along its axis, with adhesive attaching the elements together. The core may include a plurality of other elements stacked on each other and shredded into ribbons with the ribbons adhered together prior to being covered. The adhesive means is preferably water-soluble and biodegradable, as well as the bonding means. The core may be formed in whole or part of synthetic material, as well as the covering member. The element may be longitudinally scored or perforated adjacent its respective edges prior to being covered by the covering member causing the element to be bendable therealong.

Even further aspects are to be found in a roll of paperband for use in paper web cutting and turn-up systems or for use in baling including an elongate core having a longitudinal axis and a plurality of elongate elements disposed non-uniformly throughout and adhesively connected together with air spaces throughout and an elongate covering member having a central axis and thinner than and folded about the core with overlapping side portions space form and substantially parallel to the central axis. The covering member having a generally smooth outer surface extending along the core and adhesive means attaches the overlapping side portions together and bonds the core to the covering member. The adhesive means may be dispersed on the outer surface of the covering member so that the band is usable as a strapping paperband and to enable the band to adhere to itself when the adhesive is activated by heat and/or moisture and overlapped and pressed together.

In further aspects of the present invention, there is provided a roll of paperband adaptable for use in paper web cutting and turn-up systems or for use in baling, comprising an elongate core portion including a plurality of elongate elements each having a longitudinal axis and being disposed in parallel to each other; and an elongate covering member for housing the core portion therein, the covering member having a central long axis and edge portions spaced from and substantially parallel to the central axis with one edge portion facing another edge portion to substantially envelop the core portion; and adhesive means for attaching the covering member to the core portion. The core portion and covering member are formed into a thin, generally rectangular cross-sectional shape. The adhesive means coats each of the plurality of elements transverse the longitudinal axis to attach each element to an adjacent element along their lengths. The core portion and the covering member are formed of paper and the adhesive is water-soluble.

In another embodiment there is provided a roll of paperband adaptable for use in paper web cutting and turn-up systems or for use in baling, comprising an elongate core portion including a plurality of elongate elements each having a longitudinal axis and being disposed substantially in parallel to each other; at least one elongate covering member for housing the core portion therein, the at least one covering member having a central long axis and side portions spaced from and substantially parallel to the central axis with one side portion position to overlap another side portion; first adhesive means for attaching one side portion to another side portion; and second adhesive means for attaching the core portion to at least one covering member. The second adhesive means includes an adhesive coat enclosing the core portion. The second elongate covering member for housing the core portion and the at least one covering member therein. The second covering member has a central portion having a long axis and side portions spaced from and substantially parallel to the central portion with one side portion positioned to overlap another side portion, third adhesive means for attaching the one side portion to the another side portion. Each covering member is made of paper and each adhesive means is water-soluble. Fourth adhesive means secures the second covering member to the core portion. The core portion and the covering member are formed into a generally rectangular cross-section shape.

In a further aspect of the invention, there is provided a roll of paperband adaptable for use in paper web cutting and turn-up systems or for use in baling, comprising an elongate core member having top and bottom portions and spaced side portions including a plurality of elongate elements each having a longitudinal axis and being disposed in parallel to each other; and an elongate covering member for housing the core member therein the covering member having a central portion with a long axis and a first and second side portions spaced from and substantially parallel to the long axis with the first side portion positioned to overlay the top portion of the core member and the second side portion positioned to overlap the bottom portion of the core member, and attaching means for securing the covering member to the top and bottom portions of the core member. The attaching means includes water-soluble adhesive and the core member and the covering member are made of paper. The core member and the covering member are formed into a generally rectangular cross-section shape.

Also included is an elongate housing member having a central portion with a longitudinal axis and two side portions spaced from and substantially parallel to the longitudinal axis, one side portion overlapping the first side portion of the covering member and another side portion positioned to overlap the second side portion of the covering member, securing means for securing the housing member to the covering member. The securing means includes a first adhesive means disposed between one side portion and the first side portion and a second adhesive means disposed between the another side portion and the second side portion. The housing member is formed into a generally rectangular cross-section shape and is made of paper and the securing means is water-soluble adhesive.

In further aspects of the invention there is provided a roll of paperband adaptable for use in paper web cutting and turn-up systems or for use in baling including an elongate core portion including at least one elongate element having a longitudinal axis; an elongate covering member for housing the core portion therein having a central long axis and edge portions spaced from and substantially parallel to the central axis with one edge portion facing another edge portion to substantially envelop the core portion; and water-soluble adhesive means for attaching the covering member to the core portion. The core portion and covering member are formed into a thin, generally rectangular cross-sectional shape and are made of paper. The adhesive means coats each plurality of elements transverse the longitudinal axis to attach each element to an adjacent element along their lengths. When the band is used for baling it includes an outer coating of water-soluble adhesive.

In another aspect of the invention a roll of paperband adaptable for use in paper web cutting and turn-up systems or for use in baling paperband comprising; an elongate core portion including a plurality of elongate elements each having a longitudinal axis and being disposed substantially in parallel to each other; at least one elongate covering member for housing the core portion therein having a central long axis and side portions spaced from and substantially parallel to the central axis with one side portion positioned to overlap another side portion; first adhesive means for attaching one side portion to another side portion; and second adhesive means for attaching the core portion to the at least one covering member. The at least one element is an elongate planar paper member of generally rectangular cross-section, and is formed of paper. Longitudinal scoring on the exterior surfaces of said paperband may be included. The roll of paperband further includes a second elongate element having a longitudinal axis with both elements being planar and having generally rectangular cross-sectional shapes, one element overlying and in sliding contact with other element and being substantially free of any of adhesive means therebetween. There may be scoring on the exterior surfaces transverse to the axes. The second adhesive means includes an adhesive coat enclosing said core portion. A second elongate covering member houses the core portion and the covering member therein. The second covering member has a central portion having a long axis and side portions spaced from and substantially parallel to the central portion with one side portion positioned to overlap another side portion, third adhesive means for attaching one side portion to another side portion. Each covering member is made of paper and each adhesive means is water-soluble. The fourth adhesive means is used for securing the second covering member to the core portion. The core portion and the covering member are formed into a generally rectangular cross-section shape. When the paperband is used for baling it includes an outer coating of water-soluble adhesive.

In yet another aspect of the present invention there is a roll of paperband adaptable for use in paper web cutting and turn-up systems or for use in baling including an elongate core member having top and bottom portions and spaced side portions including a plurality of elongate elements each having a longitudinal axis; an elongate covering member for housing the core member therein having a central portion with a long axis substantially coincident with the longitudinal axis and a first and second side portion spaced from and substantially parallel to the long axis with the first side portion positioned to overlay the top portion of the core member; the central portion is positioned to overlay the bottom portion of the core member, and the second side portion overlaying the first side portion; and attaching means for securing the covering member to the top and bottom portions of the core member. The attaching means includes water-soluble adhesive and the core member and the covering member are made of paper. The core member and the covering member are formed into a generally rectangular cross-section shape.

In addition an elongate housing member has a central portion with a longitudinal axis and two side portions spaced from and substantially parallel to the longitudinal axis, one side portion overlapping the first side portion of the covering member and another side portion positioned to overlap the second side portion of the covering member and securing means for securing the housing member to the covering member. The securing means includes a first adhesive means disposed between one side portion and the first side portion and a second adhesive means disposed between another side portion and the second side portion. The housing member is formed into a generally rectangular cross-section shape and is made of paper and the securing means is water-soluble adhesive.

Further aspects of the include a paperband with the at least one elongate element being a planar member of generally rectangular cross-section and spaced parallel side portions, the core portion further including a pair of spaced elongate components each having a long axis and respectively disposed adjacent respective side portions of the planar member and each long axis being parallel to the longitudinal axis. The adhesive means for attaching the covering member also attaches each component to the planar member. A further feature is disclosed by including a pair of spaced elongate components disposed adjacent respective side portions of the pair of planar members another side portions of the second element with each long axis of the components being parallel to the lengthwise axis of the planar members. The adhesive means attaches each component to the pair of planar members.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view of a paperband in accordance with one embodiment of the present invention;

FIG. 2 is a perspective view of a second embodiment of the paperband shown in FIG. 1 wherein the core is flattened into a generally cross-sectional shape;

FIG. 2A is a perspective view of a roll of paperband as shown in FIG. 2;

FIG. 3 is a perspective view of a third embodiment of the paperband shown in FIG. 2 wherein the paperband includes a bulging medial cavity and serrated outer side edge portions;

FIG. 4 is a perspective view of a fourth embodiment of the paperband shown in FIG. 2 wherein the core is fabricated to produce a convoluted pattern and then collapsed into a generally rectangular flattened core;

FIG. 4A is an end elevational view of the core of FIG. 4 with a covering member wrapped therearound;

FIG. 5 is a perspective view of a fifth embodiment of the paperband shown in FIG. 2;

FIG. 6 is a perspective view of a sixth embodiment of the paperband shown in FIG. 2;

FIG. 7 is an end elevational view of the paperband of FIG. 6;

FIG. 8 is a perspective view of a paperband shown partially broken away in accordance with a seventh embodiment of the present invention;

FIG. 9 is an end elevation diagrammatic view of the paperband of FIG. 8;

FIG. 10 is an end elevation diagrammatic view of a paperband in accordance with an eighth embodiment of the present invention;

FIG. 11 is an end elevation diagrammatic view of a paperband in accordance with a ninth embodiment of the present invention;

FIG. 12 is an end elevation diagrammatic view of a paperband in accordance with a tenth embodiment of the present invention;

FIG. 13 is an end diagrammatic view of a paperband in accordance with an eleventh embodiment of the present invention;

FIG. 14 is an end diagrammatic view of a paperband in accordance with a twelfth embodiment of the present invention;

FIG. 15 is end diagrammatic view of the paperband of FIG. 13 showing an external coating of water-activated adhesive;

FIG. 16 is an end diagrammatic view of a paperband in accordance with a thirteenth embodiment of the present invention;

FIG. 17 is an end diagrammatic view of a paperband in accordance with a fourteenth embodiment of the present invention;

FIG. 18 is an end diagrammatic view of a paperband in accordance with a fifteenth embodiment of the present invention; and

FIG. 19 is an end diagrammatic view of a paperband in accordance with a sixteenth embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this application will be thorough and complete, and will fully convey the true scope of the invention to those skilled in the art. Like numbers refer to like elements throughout, and prime and double prime notations are used to indicate similar elements in alternative embodiments.

The paperband of this invention is referred to generally in FIG. 1 by reference numeral 10. Such a paperband includes an elongate core member 11 that extends along the length of the paperband 10. The core member 11 is formed from an elongate flat paper element 12 that is creased and gathered so that it has a non-planar and non-uniform outer surface 13. The element 12 has randomly spaced creases 14 along its longitudinal axis extending along its length. When the creases 14 of paper element 12 are compressed against each other, a tough outer surface 13 provides high tensile strength for the paperband to be used in spooling and turn-up as shown by U.S. Pat. No. 5,954,290, or baling as shown in U.S. Pat. No. 5,560,180.

An adhesive 15 is sprayed on the elongate element 12 to cover its outer surface 13 and is dispersed in some of the creases and will ultimately stiffen same and increase the tensile strength of the paperband. The adhesive 15 may be a conventional adhesive, such as PVA, as readily known in the paper industry and is preferably water-soluble so that it can be recycled during pulping operations. The adhesive may also be biodegradable for not damaging the environment should the paperband not be recycled.

Element 12 also could be twisted or rotated about its respective longitudinal axis for providing additional tensile strength. Thus, as element 12 is twisted, it is more tightly wrapped about its axis to provide a stiffer core 11. Such a stiffer core 11 assists in providing better cutting performance during turn-up operations and baling operations. Of course, the elements 12 may be formed from varying combinations of engineered materials to create a multiplicity of tensile and torsion strengths.

A covering member 16 is folded about the core 11 and is bonded thereto by the adhesive 15, which is preferably applied uniformly along the core 11 of the paperband 10 or may be applied to member 16. The outer surface 17 of the covering member 16 is generally smooth and planar but is sufficiently thin for allowing the covering member 16 to conform to the contoured cross-sectional shape of the element 12. Accordingly, the covering member 16 maintains substantially continuous contact around the core 11 and forms a substantially rectangular or cylindrical cross-sectional shape thereabout when the paperband 10 and adhesive dry.

The covering member 16 includes overlapping side portions 18, 19 oppositely spaced from its longitudinal axis and extending parallel thereto along the length of the paperband 10. The overlapping side edge portions 18, 19 extend equidistantly and inwardly from sides 20, 21, respectively, and overlap for bonding together. Such overlapping side portions 18, 19 are preferably bonded by adhesive 22 which may be the same type of adhesive as adhesive 15 previously described. The bonding of the overlapping side portions 18, 19 envelopes the core and prevents same from separating during use of the paperband in normal operating conditions.

During the gathering process or immediately following this process, the core 11 can be sprayed, coated or otherwise treated, in a manner well-known in the art, with a water-soluble adhesive in order to enhance the rigidity of the core and the resultant paperband 10 in a fixed geometry. Further, the paperband 10 may be coated with specialty chemicals for providing the paperband with engineered properties such as fire retardant and water repellent properties, as well known in the art.

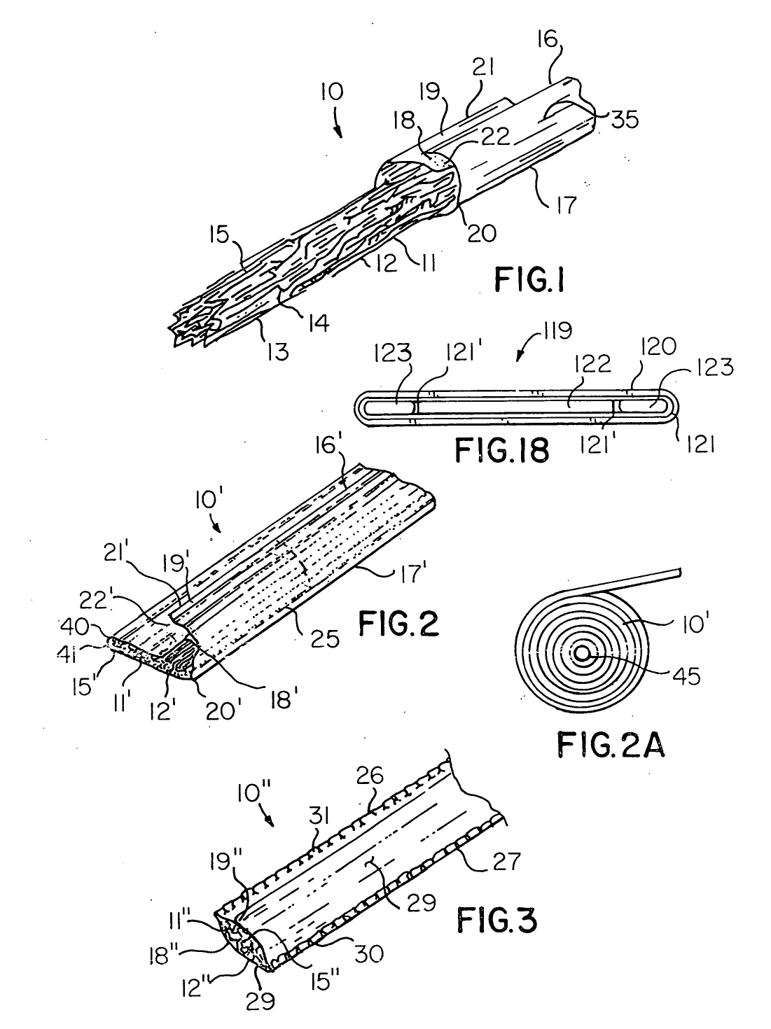

Now referring to FIGS. 2 and 2A, an alternate embodiment of the present invention is shown wherein a roll of paperband 10′ is wrapped about a central element 45, as well known in the art. The paperband 10′ includes a core 11′ that preferably includes at least another one of the elements 12′ extending along the length thereof. In particular, the paperband 10′ may include a plurality of elements 12′ coated with adhesive 15′ for bonding such elements 12′ to each other and for providing stiffness thereto. Such elements are positioned to form side-by-side rows 40 and 41 and may be individually twisted about their respective longitudinal axis. Of course, the core 11′ may include various amounts of element 12′ and should not be limited to the embodiment 10′ as shown in FIG. 2.

Similar to the previous embodiment shown in FIG. 1, the covering member 16′ includes overlapping side portions 18′, 19′ oppositely spaced from a longitudinal axis and extending parallel thereto along the length of the paperband 10′. The overlapping side portions 18′, 19′ extend equidistantly and inwardly from sides 20′, 21′, respectively and overlap each other for bonding together. Such overlapping side portions 18′, 19′ are preferably bonded together by adhesive 22′, which may be the same as adhesive 15.

Of course, the embodiment of FIG. 2 could be formed from the embodiment of FIG. 1 by passing the paperband 10 through a pair of rollers (not shown) prior to full curing or hardening of the adhesive in the core member 12′, as would occur to persons skilled in the art. Such a feature of the the paperband 10′ helps reduce markings formed on a paper web (not shown), which are normally produced by non-compressible or non-deformable paperbands. Also, such a compressible paperband helps reduce crossover when traveling through a nip in turn-up applications, as readily known in the art. The compressible characteristics of the paperband 10′ allow it to have a multiplicity of slenderness ratios (width divided by thickness) for providing various stiffness properties. The covering member 16′ may also include a plurality of creases 25 extending longitudinally along its length for preventing crimping thereof during operating conditions.

Now referring to FIG. 3, yet another embodiment of the present invention is shown wherein a paperband 10″ includes outer side edge portions 30, 31 and a cavity 29 disposed between the outer side edge portions 30, 31. Both the cavity 29 and outer side edge portions 30, 31 extend along the length of the paperband 10″ with the center of the cavity 29 being aligned along the longitudinal axis of the paperband 10″ and thereby causing to bulge therealong, for reasons explained hereinbelow.

The cavity 29 envelops the core 11″ including one or a plurality of elements 12″ disposed adjacent to each other along their respective lengths. Such elements 12″ may randomly be placed in a non-uniform pattern next to each other so that the cavity 29 will bulge at the center thereof. Again, such paperband 10″ may be formed by passing it through a pair of opposed rollers (not shown) having a slight depression in each surface thereof to produce the paperband 10″. The covering member 16″ overlaps at its side portions 18″, 19″, similar to the previous embodiments, and are bonded to each by an adhesive 22″. The elements 12″ may also be twisted about the respective longitudinal axis and include adhesive 15″ thereon for bonding to each other.

The outer side edge portions 30, 31 are preferably thin and pliable and extend equidistantly inward from the outer side edges of the paperband 10″. Such outer side edge portions 30, 31 extend substantially parallel to the longitudinal axis and along the length of the paperband and preferably include creases 26, 27 extending laterally thereacross for providing a serrated edge and for enhancing the cutting performance of the paperband 10″ during spooling operations. Such creases 26, 27 may be substantially equally spaced apart or selectively disposed along the length of the outer side edge portions 30, 31 and preferably do not penetrate through the surfaces thereof. Such creases 26, 27 may also be provided by the same rollers (not shown) mentioned hereinabove to form a bulge along the mid-portion of the paperband or can be provided by two opposing pairs of spaced rollers positioned along the respective edges of the paperband.

The above-mentioned embodiments of the present invention are preferably formed from repulpable materials such as paper or conventional synthetic materials known in the art. The materials selected may be of various physical and/or chemical properties such as tensile strength, wet strength, extensibility, etc., to allow for maximizing the band for the intended application and use required. All adhesives are preferably water-soluble and/or biodegradable so that they may be recycled during repulping operations. The thickness of the paper used to form the covering member and the core elements may vary so that the thickness of the covering member is preferably thinner than the thickness of the resulting core elements.

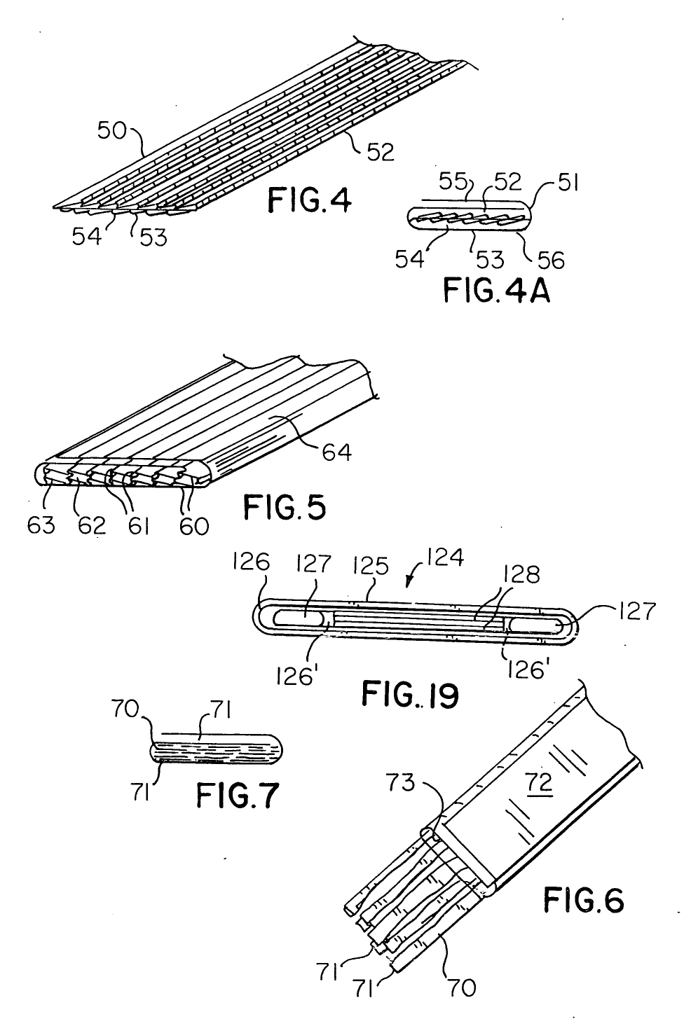

Now referring to FIG. 4, another embodiment of the present invention is depicted wherein the inner core 50 that extends the entire length of the paperband 51 is shown as being formed of an elongate flat paper element that has non-planar outer surfaces 52 and 53 that are convoluted along its entire length. The convolutions 54 are compressed together and a tough outer layer or covering 55 is adhered to the core 50 and to itself. An adhesive is applied to the inner core 50 to stiffen and create a matrix with core 50 of the band 51 and be a conventional water-soluble PVA adhesive and can be biodegradable. The outer surface 56 of the band 51 can also be coated with a water-soluble adhesive so that the band 51 may bond to itself when used in a bale strapping operations as bands had been commonly used.

As previously discussed the inner core 50 and the outer covering 55 may be of various materials to secure appropriate physical properties having a multiplicity of attributes, such as tensile strength, stiffness, compressibility of the band between its upper and lower surfaces can be achieved.

FIG. 5 depicts another embodiment with multiple layers 60 of folds or creases 61 extending longitudinally and forming core 62. These layers 60 are convoluted along their lengths and are collapsed and adhered to each other, as previously explained above, to form-a non-uniform outer surface 63 to core 62. The covering 64 is wrapped around core 62 and is adhered thereto and to itself as previously described.

FIGS. 6 and 7 set forth another embodiment of this invention wherein the core 70 is formed from a plurality of cut ribbons of paper 71, substantially similar to that produced in the common non-crosscut paper shredding machines, and gathered to form the core 70. The ribbons of paper would be sprayed or dipped into liquid PVA as heretobefore described, and wrapped with a covering 72 and coated thereabout with adhesive. This embodiment would have advantages over the various folded embodiments by being less susceptible to perpetuation of a cross tear, having greater ability to twist, as when exiting a track beneath a paper web severing the web and transferring the web onto an empty spool. Also a more evenly filled cavity 73 may be accomplished by this embodiment of the invention.

The paperband depicted in FIGS. 8-19 may be constructed with longitudinal yarns to which adhesive has been applied, such yarns being enclosed by an envelope that may be of the same or a different paper grade. The assembly is formed in a manner to have a uniform cross-section and continuous length. The adhesive may be applied to the envelope(s) rather than to or in addition to the yarns. The principal advantages provided by such an approach are as follows.

1. The band of the prior art made from individual yarns glued together requires that the paper used must be a light basis weight because of the relatively high level of twist per inch that is necessary. The paperband used herein allows for a wider grade of paper materials because of the influence of the envelope used with regard to width and the calendering of the flat side(s) to define the band thickness, as will be described hereinbelow.

2. Because the highly twisted yarns of the prior art may not be used and the fact that a significant amount of the strength is achieved by the envelope used, the wetting action in repulping processes is faster. In addition, less adhesive need be used compared to the prior art gluing of the highly twisted yarns along their lengths as the sole attachment to form the prior art paperband.

3. In applications where the paperband is made for automatic strapping, the outer layer of the envelope may be pre-coated with a water-activated adhesive.

4. In applications of the paperband where no water-activated adhesive is needed, the outer surface of the envelope may be manufactured more economically and/or may be coated with a substance to increase the bands slideability, protection from weather conditions, etc.

5. Flexibility in design configuration results because the use of natural material can be incorporated inside the envelope. Material, such as hemp or cotton or cotton linters may be used inside the envelope. Such flexibility is not always possible with conventional bands.

6. The paperband is manufactured with fewer steps than previous bands thus reducing waste and the energy used to manufacture such bands.

7. The use of the envelope to enclose the main body of the band provides a paperband with improved resistance to heat and moisture and thus has enhanced stability. Furthermore, the protection provided by the envelope extends to abnormal temperature and moisture conditions. The internal materials and adhesive forms a matrix, somewhat akin to the matrix formed in plywood.

8. Dimensional uniformity is maintained by controlling the width of the paperband with a predetermined scoring process applied to the envelope as will be more fully discussed hereinbelow.

9. The conventional twisted strand paperband may include glue that provides a very small number of contact points between the yarns. A lack of cohesion due to abrasion or moisture effect on the adhesive may result. The use of the envelope in the improved paperband greatly reduces the loss of cohesion that affects other bands.

A paperband in accord with the seventh embodiment of the present invention is shown at numeral 74 in FIG. 8 with a plurality of longitudinal yarns 75 arranged in parallel and spaced apart forming a core. An envelope having side edge portions 79, 80 and central long axis 81 surrounds yarns 75. Side edge portions 79, 80 are formed to be substantially parallel to axis 81.

FIG. 9 illustrates an end view of the paperband of FIG. 8. Adhesive 77 is used to attach one side edge portion 79 to another side edge portion 80 that overlaps the first portion 79. Adhesive coat 78 envelops yarns 75 and adheres the yarns 75 to envelope 76. Adhesive 77 and adhesive coat 78 may be the same and applied to the inside of envelope 76, as would be understood in the art.

With respect to FIG. 10, an eighth embodiment of the paperband is shown at 82. The paperband 82 encloses a core portion formed as a central section substantially identical to the paperband 74 shown in partial broken lines in FIG. 10. Envelope 83 has side portions 84 and 85 bonded together with adhesive layer 86. An adhesive coating 87 bonds envelope 83 to paperband core 74. Again, adhesive layer 86 and adhesive coating 87 may be the same.

With respect to FIG. 11, a ninth embodiment of the paperband is shown at 88. An envelope 89 does not employ the side portions bonded together as in the embodiments described hereinabove. Rather, envelope 89 is formed as a longitudinal sleeve enclosing a core portion of yarns 91 and adhesive coating 90. Gap 92 is the result of the manufacturing process that is employed wherein the long edges of the envelope 89 need not necessarily overlap.

FIG. 12 illustrates a tenth embodiment of the paperband identified by numeral 93 that includes a core portion formed as a center portion that is substantially identical to paperband 88 of FIG. 11. A second adhesive coating 95 binds an outer envelope 94 to the inner envelope 89 that includes gap 96.

FIG. 13 illustrates an eleventh embodiment of the paperband identified by numeral 97 according to the present invention and illustrates an inner folded envelope 99 open at one long end with an adhesive coating 100 enclosing a core portion formed of yarns 102. An outer folded envelope 98 with sides 98′, 98″ encloses inner folded envelope 99 having sides 99′ 99″, adhesive coating 100, and yarns 102 and is bonded to inner envelope 99 via two adhesive layers 101 that is preferably of the same material as coating 100. It is understood that adhesive layers 101 may be substantially continuous over the inner surface of envelope 98.

FIG. 14 illustrates a twelfth embodiment of the paperband identified by numeral 103. The envelope wrap 104 and adhesive coating 105 may be any of the envelopes/adhesives used in FIGS. 8-13. What distinguishes this embodiment is the use of yarns 106 and 107 having different diameters or different dimensions and the fact that yarns 106, 107 are shown in contact with each other, these features may be incorporated in any of the paperbands 74, 82, 88, 93, 97, and other embodiments herein.

FIG. 15 is similar to FIG. 13 and illustrates the use a water-activated adhesive 108 on the exterior surface of paperband 97 of FIG. 13 for use in strapping application. Water-activated adhesive 108 may be used on the exterior surface of each paperband 72, 82, 88, 93, 103, and other embodiments herein.

FIG. 16 illustrates a paperband 109 including an envelope 110, an adhesive coating 111 and a core 109′ including two superimposed elongate planar paper elements 112, 113 having a substantially non-existent space 114 therebetween to illustrate the relationship of the components. No additional adhesive is used in space 114 between the elements thus allowing a slight sliding movement between the two elements, particularly when the paperband 109 is wound into a roll as shown in FIG. 2A. The adhesive coating 111 contacts substantially the exposed outer lower and upper surfaces of respective elements 112, 113 and the inner surface of envelope 110. In addition, transverse (or cross-wise) scoring may be employed to further enhance for winding into a roll without any significant reduction in stiffness and/or tensile strength.

FIG. 17 illustrates a paperband 115 having an envelope 116 and an adhesive coating 117 around a single planar paper element 118 that is sized in thickness and width to allow it to be pushed into and through a track used in a turn-up system or the track used in a banding system. The elements 112, 113 in FIG. 16 may also be sized with the same objective in mind. Finally, longitudinal scoring and exterior water-soluble adhesive may be used on either band 109 or 115 as hereinbefore described.

In FIG. 18, an alternate embodiment of a paperband 119 is shown and includes envelope 120, adhesive coating 121 and a planar member 122 substantially similar to paperband 117. Member 122 however is narrower than member 118. Components such as in yarns 123 are positioned along the sides of member 122 and are attached via adhesive 121′ (which may be the same as 121 as being, for example, applied on the envelope 120). The paperband 119 provides for bending of the paperband 119 as it is removed from a track, for example, and as more fully described in connection with FIGS. 3 and 6. If desired, the adhesive 121 (121′) may extend only on the upper and lower surfaces of member 122 or only on the central long portions or in spaced strips to generally adhere envelope 120 to member 122 resulting in the yarns 123 being non-adhesively encapsulated within envelope 120. Of course, after calendering, such a construction would even permit greater flexibility along the edges and thus friction is reduced by the paperband exiting a slot in a cross machine track of a turn-up system.

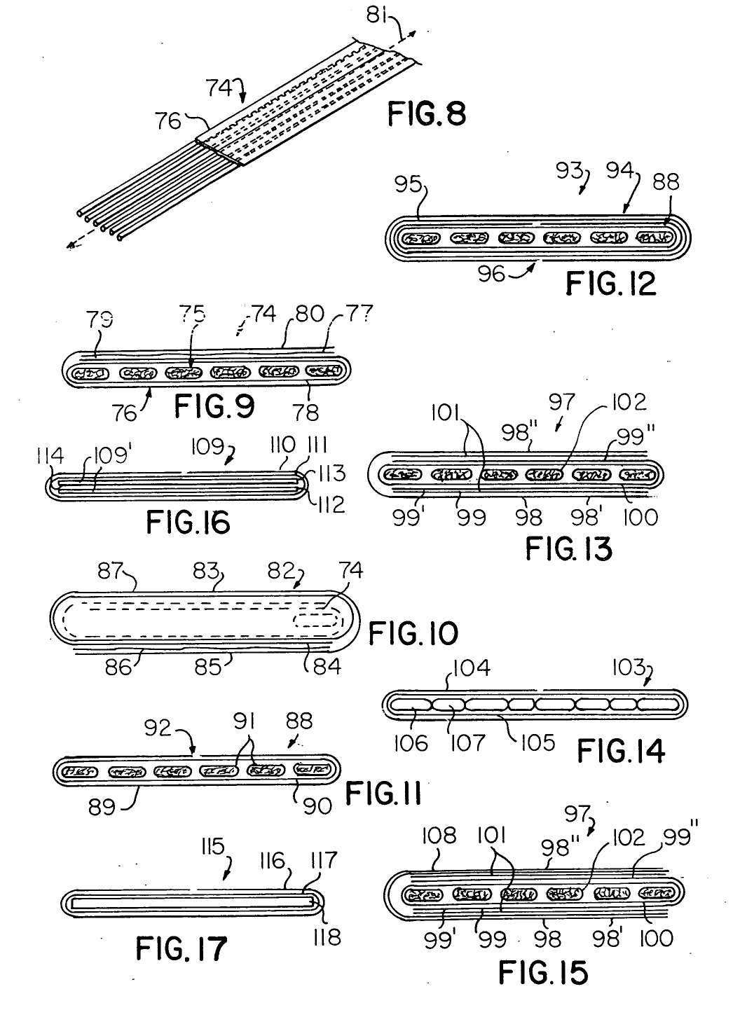

In FIG. 19, another embodiment of the paperband 124 is illustrated having an envelope 125, an adhesive coating 126 and two elongate components or yarn members 127 attached outside of two planar elements 128 via adhesive 126′ again providing for bendability in applications where it is desired.

The embodiments of FIGS. 18 and 19 may have external adhesive, if so desired, to be used in baling applications and may include further envelopment as in the embodiments of FIGS. 10, 12 and 15 if desired, for various applications of use. In addition, longitudinal scoring may be employed and/or cross-scoring as hereinabove set forth.

All members of each paperband 74, 82, 88, 93, 97, 103, 119 and 124 are deformable by calendering to provide that each paperband has a substantially rectangular cross-section. Moreover, the yarns, whether more or less than the six shown, and envelope members may be made of either paper of various weights and composition or various synthetic materials depending upon the application. All adhesives used are preferably water-soluble to aid in repulping of used paperband when desired. The adhesives, particularly in each of the FIGS. 8-19, need not be continuous with the envelopes attaching the core or core members to each other and/or to itself. Accordingly, while the adhesives are generally shown as being continuous, they may be spaced strips of adhesive or discontinuous, as set forth hereinabove with respect to, for example, FIG. 18. In each of the FIGS. 8-19, the respective adhesive coating utilized therein also may occupy the entire space around the elongate members that form the central core portion to provide a paperband that is a generally solid structure, but the adhesive and/or the elongate members or yarns may also include scattered air spaces or pockets, without departing from the herein disclosed invention. Finally, all embodiments may be rolled as illustrated in FIG. 2A.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

1. A roll of paperband adaptable for use in paper web cutting and turn-up systems or for use in baling, said paperband comprising:
an elongate core portion including at least one elongate element having a longitudinal axis;
an elongate covering member for housing said core portion therein, said covering member having a central long axis and edge portions spaced from and substantially parallel to said central axis with one said edge portion facing another said edge portion to substantially envelop said core portion; and
adhesive means for attaching said covering member to said core portion.

2. The roll of paperband of claim 1 wherein said core portion and said covering member are formed into a thin, generally rectangular cross-sectional shape.

3. The roll of paperband of claim 1 wherein said core portion includes another elongate element, said adhesive means attaching each said element to an adjacent said element along their lengths.

4. The roll of paperband of claim 1 wherein said core portion is formed of paper.

5. The roll of paperband of claim 1 wherein said covering member is formed of paper.

6. The roll of paperband of claim 1 wherein said core portion, said covering member and said adhesive means are water-soluble.

7. The roll of paperband of claim 1 wherein said paperband when used for baling includes an outer coating of water-soluble adhesive when said band is intended to be used for baling.

8. The roll of paperband of claim 1 wherein said at least one elongate element is a planar member of generally rectangular cross-section and spaced parallel side portions, said core portion further including a pair of spaced elongate components each having a long axis and respectively disposed adjacent respective said side portions of said planar member, each said long axis being parallel to said longitudinal axis.

9. The roll of paperband of claim 8 further including adhesive means for attaching each said component to said covering member.

10. The roll of paperband of claim 1 wherein said at least one element is an elongate planar paper member of generally rectangular cross-section.

11. The roll of paperband of claim 1 wherein said core portion and said covering member are formed of paper.

12. The roll of paperband of claim 10 further including longitudinal scoring on exterior surfaces of said paperband.

13. The roll of paperband of claim 10 further includes a second elongate element having a longitudinal axis, said second element being planar and having generally rectangular cross-sectional shapes, one said element overlying and in sliding contact with said other element.

14. The roll of paperband of claim 13 further including a pair of spaced elongate components each having a long axis and respectively disposed adjacent side edge portions of said at least one element and said second element with all said axes being substantially parallel.

15. The roll of paperband of claim 10 further including a second elongate covering member for enclosing said core portion and said at least one covering member therein.

16. The roll of paperband of claim 15 wherein said second covering member has a central portion having a long axis and side portions spaced from and substantially parallel to said central portion with one side portion positioned to overlap another said side portion, said adhesive means attaching said one side portion to said another side portion.

17. The roll of paperband of claim 15 wherein each said covering member is made of paper and said adhesive means is water-soluble.

18. The roll of paperband of claim 17 further including adhesive means for securing said second covering member to said first covering member.

19. A roll of paperband adaptable for use in paper web cutting and turn-up systems or for use in baling, said paperband comprising;
an elongate core portion including a plurality of elongate elements each having a longitudinal axis and being disposed substantially in parallel to each other;
at least one elongate covering member for housing said core portion therein, said at least one covering member having a central long axis and side portions spaced from and substantially parallel to said central axis with one said side portion positioned to overlap another said side portion; and
adhesive means for attaching said one side portion to said another side portion and for attaching said core portion to said at least one covering member.

20. The roll of paperband of claim 19 wherein said core portion and said covering member are formed into a generally rectangular cross-section shape.

21. The roll of paperband of claim 19 wherein said paperband includes an outer coating of water-soluble adhesive when said band is intended for use in baling.

22. The roll of paperband of claim 1 wherein said core portion includes a pair of elongate elements each having a planar member of generally rectangular cross-section and spaced parallel side portions having a lengthwise axis, said core portion further including a pair of spaced elongate components each having a long axis and respectively disposed adjacent respective said side portions of said planar member, each said long axis being parallel to said longitudinal axis.

23. The roll of paperband of claim 22 wherein said adhesive means for attaching each said component to said covering member.

24. The roll of paperband of claim 19 wherein said adhesive means includes an adhesive coat enclosing said core portion.

25. A roll of paperband adaptable for use in paper web cutting and turn-up systems or for use in baling, said paperband comprising:
an elongate core member having top and bottom portions and spaced side portions including a plurality of elongate elements each having a longitudinal axis;
an elongate covering member for enclosing said core member therein, said covering member having a central portion with a long axis substantially coincident with said longitudinal axis, said member having a first and second side portions spaced from and substantially parallel to said long axis with said first side portion positioned to overlay said top portion of said core member;
said central portion positioned to overlay said bottom portion of said core member, and said second side portion overlaying said first side portion;
and attaching means for securing said covering member to said top and bottom portions of said core member.

26. The roll of paperband of claim 25 wherein said attaching means includes water-soluble adhesive.

27. The roll of paperband of claim 25 wherein said core member and said covering member are made of paper.

28. The roll of paperband of claim 25 wherein said core member and said covering member are formed into a generally rectangular cross-section shape.

29. The roll of paperband of claim 25 further including another elongate covering member having a central portion with a longitudinal axis and two side portions spaced from and substantially parallel to said longitudinal axis, one said side portion of said another covering member overlapping said first side portion of said covering member, and another said side portion of said another covering member positioned to overlap said one side portion of said another covering member, another attaching means for securing said overlapped portions of said another covering member together.

30. The roll of paperband of claim 25 wherein said elongate elements include a pair of side elements disposed and forming said side portions of said core member, said pair of side elements being free from attachment to other said elements forming said core member.

31. The roll of paperband of claim 25 wherein said covering member is defined by an inside covering member and an outside covering member.

32. The roll of paperband of claim 25 wherein said covering member is paper and said attaching means is water-soluble adhesive.

33. The roll of paperband of claim 25 wherein said paperband includes an outer coating of water-soluble adhesive.
